(19) United States
(12) Patent Application Publication
(10) Pub. No.: US 2017/0270527 A1
(43) Pub. Date: Sep. 21, 2017

(54) ASSESSING TRUST TO FACILITATE BLOCKCHAIN TRANSACTIONS

(71) Applicant: JOHN RAMPTON, Palo Alto, CA (US)

(72) Inventor: JOHN RAMPTON, Palo Alto, CA (US)

(21) Appl. No.: 15/073,627

(22) Filed: Mar. 17, 2016

(51) Int. Cl. G06Q 20/40; G06Q 20/10

(52) U.S. Cl. CPC G06Q 20/4016; G06Q 20/102; G06Q 2220/00

(57) ABSTRACT

In some embodiments, an online payment system may assess the trust of one or more users to dispense with a waiting period normally associated with online money transfers. Such assessment of trust may include aggregating online activity performed by a user of the online payment system, analyzing the online activity, categorizing the activity, and assigned a trust score to each activity, then summing the trust scores for the user. For users with trust scores above a predetermined threshold level, the online payment system may dispense with a waiting period normally associated with online money transfers. This may be done in the context of blockchain transactions.

### FIELD OF THE INVENTION

This disclosure generally relates to performing financial transactions over a wireless network.

### BACKGROUND OF THE INVENTION

Financial transactions have traditionally been performed or monitored by trusted third parties, such as governments, banks, and other financial institutions. Blockchain technology allows financial transactions to occur without the involvement of trusted third parties. This may be accomplished through a network of computers (e.g., the Internet) creating and updating in real time a universal ledger on which financial transactions are recorded. This universal ledger is neither closed nor under the control of one party. The universal ledger may be public and fully distributed across the network. This universal ledger may also be referred to as the blockchain. In the blockchain, all transactions are logged, including information on the time, date, participants, and amount of every transaction. Each node in network may own a full copy of the blockchain. The transactions on the blockchain may be verified by software. All transactions may be required to be agreed upon by all nodes in the network.

The blockchain may enable the use of cryptocurrency. Cryptocurrency may be understood to be a digital currency used as a medium of exchange that uses cryptography and encryption to secure transactions without the oversight of a trusted third party. One example of cryptocurrency is bitcoin, although many different types of cryptocurrencies have been created.

### SUMMARY OF PARTICULAR EMBODIMENTS

In various embodiments, a system and method for verifying trusted users in blockchain transactions is discussed. A blockchain transaction may be a transaction that is conducted using blockchain technology. When an Automated Clearing House (ACH) transaction is conducted, a trusted third party usually needs to verify the identities of at least one of the transacting parties in order to facilitate the transfer of money. This verification period usually takes two to three days to complete. This inconveniences both payer and payee because both parties arc unsure if them money has actually been transferred until two to three days after the transaction is completed.

An online payment system may utilize blockchain technology to dispense with this waiting period by assessing a trust score for one or more transacting parties. If the online payment system can verify a user's identity before a transaction is requested, or if the online payment system can verify that the user is a legitimate person (e.g., not a scam company or robot) before a transaction is requested, this may facilitate faster blockchain transactions because the waiting period normally associated with financial transactions may be eliminated. The online payment system may track, gather, or may otherwise have access to online activities of one or more users of the online payment system. The online payment system may categorize each of the activities, and, based on the categorizations, may determine a trust score for one or more users. For example, the online payment system may track, gather, or otherwise have access to the following activities performed by a user: setting up an online social networking account, posting photos or other content to an online social network, liking, commenting on, or following content on an online account, providing proof of identification to online subscription services, or any other suitable online activity. The categorization may determine how trustworthy a user is. For example, setting up an account on an online social network may be categorized into a first category, posting photos, may be categorized into a second category, and providing detailed information about one's self (e.g., email address, phone number, identification) may be categorized into a third category. The online payment system may assign a trust score to each action with its corresponding categorization. For example, activities that are categorized into the first category may receive a trust score of “1;” activities that are categorized into the second category may receive a trust score of “2;” and activities that are categorized into the third category may receive a trust score of “3.” The online payment system may sum all the trust scores from all the activities performed by a user over a predefined period of time (e.g., the last six months, year, two years, etc.) and determine an overall trust score for the user. This trust score may indicate whether or not the user is trustworthy enough to dispense with the normal waiting period associated with ACH payments. If the trust score is above a predetermined threshold level (e.g., 15), the online payment system may decide to dispense with the normal waiting period associated with ACH payments. This may be because the online payment system “trusts” at least one of the users enough to assume the risk normally associated with ACH payments.

In some embodiments, the online payment system may convert traditional currency into its own form of cryptocurrency. If this is the case, the online payment system may also create a universal ledger to monitor the transactions involving this cryptocurrency. This universal ledger may be maintained similar to other ledgers that monitor the transactions involving other forms of cryptocurrency (e.g., bitcoin), or it may monitor transactions in unique ways, which will be discussed herein. In some embodiments, the online payment system may guarantee an exchange rate using various algorithms which will be discussed herein.

In some embodiments, the online payment system may use the trust score of a first user to offer credit to the first user. In such a situation, the online payment system may pay a second user of the online payment system on behalf of the first user, the first user agreeing to pay the online payment system at a future date, with or without interest.

### BRIEF DESCRIPTION OF THE DRAWINGS

FIG. 1 illustrates an example diagram for using cryptocurrency to provide near instant end-to-end transactions with low associated costs,

FIG. 2 illustrates an example cryptocurrency conversion module according to particular embodiments described herein.

FIG. 3 illustrates an example method for using cryptocurrency to provide near instant end-to-end transactions with low associated costs.

FIG. 4 illustrates an example set of components of a computing device in accordance with various embodiments described herein.

FIG. 5 illustrates an example network environment in which various embodiments may be implemented.

### DETAILED DESCRIPTION OF THE DRAWINGS

In various embodiments, a system and method for verifying trusted users in blockchain transactions is discussed. A blockchain transaction may be a transaction that is conducted using blockchain technology. When an Automated Clearing House (ACH) transaction is conducted, a trusted third party usually needs to verify the identities of at least one of the transacting parties in order to facilitate the transfer of money. This verification period usually takes two to three days to complete. This inconveniences both payer and payee because both parties are unsure if them money has actually been transferred until two to three days after the transaction is completed.

An online payment system may utilize blockchain technology to dispense with this waiting period by assessing a trust score for one or more transacting parties. The online payment system may track, gather, or may otherwise have access to online activities of one or more users of the online payment system. The online payment system may categorize each of the activities, and, based on the categorizations, may determine a trust score for one or more users. For example, the online payment system may track, gather, or otherwise have access to the following activities performed by a user: setting up an online social networking account, posting photos or other content to an online social network, liking, commenting on, or following content on an online account, providing proof of identification to online subscription services, or any other suitable online activity. The categorization may determine how trustworthy a user is. For example, setting up an account on an online social network may be categorized into a first category, posting photos, may be categorized into a second category, and providing detailed information about one's self (e.g., email address, phone number, identification) may be categorized into a third category. The online payment system may assign a trust score to each action with its corresponding categorization. For example, activities that are categorized into the first category may receive a trust score of “1;” activities that are categorized into the second category may receive a trust score of “2;” and activities that are categorized into the third category may receive a trust score of “3.” The online payment system may sum all the trust scores from all the activities performed by a user over a predefined period of time (e.g., the last six months, year, two years, etc.) and determine an overall trust score for the user. This trust score may indicate whether or not the user is trustworthy enough to dispense with the normal waiting period associated with ACH payments. If the trust score is above a predetermined threshold level (e.g., 15), the online payment system may decide to dispense with the normal waiting period associated with ACH payments. This may be because the online payment system “trusts” at least one of the users enough to assume the risk normally associated with ACH payments.

In some embodiments, the online payment system may convert traditional currency into its own form of cryptocurrency. If this is the case, the online payment system may also create a universal ledger to monitor the transactions involving this cryptocurrency. This universal ledger may be maintained similar to other ledgers that monitor the transactions involving other forms of cryptocurrency (e.g., bitcoin), or it may monitor transactions in unique ways, which will be discussed herein. In some embodiments, the online payment system may guarantee an exchange rate using various algorithms which will be discussed herein.

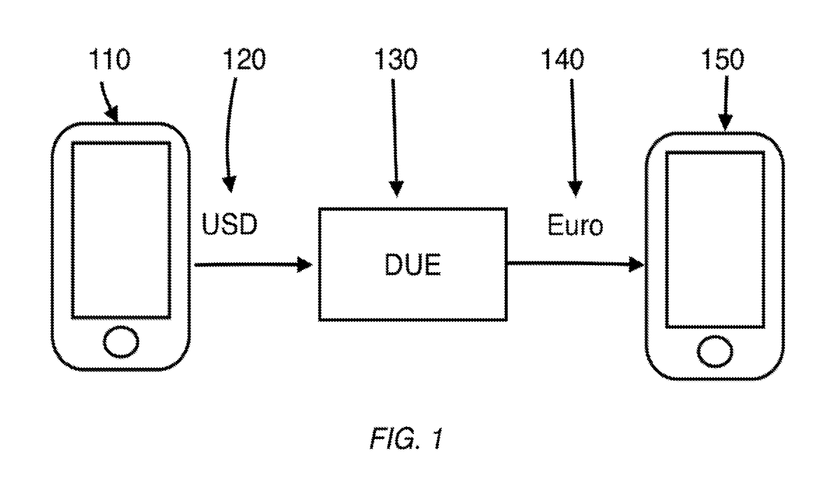

FIG. 1 illustrates an example diagram for using cryptocurrency to provide near instant end-to-end transactions with low associated costs. Illustrated are two client devices 110 and 150, a “black box” currency converter 130, and two forms of currency: USD 120 and Euro 140. It is important to note this is an example only, and any type of currency may take the place of USD 120 and Euro 140 (e.g., pesos, rupees, ariary, etc.). To illustrate how a user or users might use the invention disclosed herein, suppose a first user of client device 110 wishes to pay a second user of client device 150. The first user may live in the United States, and the second user may live in Belgium. Instead of the first user paying the second user in US dollars and the second user needing to go to a currency exchange center to obtain the value of the US dollars in Euros, the users may use the online payment system discussed in this disclosure. In various embodiments, the first user may pay the second user US dollars, and the US dollars may be converted into Euros by the online payment system by way of the currency converter 130. The second user may then receive payment in Euros. The entire process may be quick, lasting less than five minutes from payment to receipt of payment. In some embodiments, the second user may have the money deposited into her account just minutes or seconds after the first user transfers payment. From the users' perspectives, money is simply transferred, the fees may be low, and the time to conduct the transaction may be short.

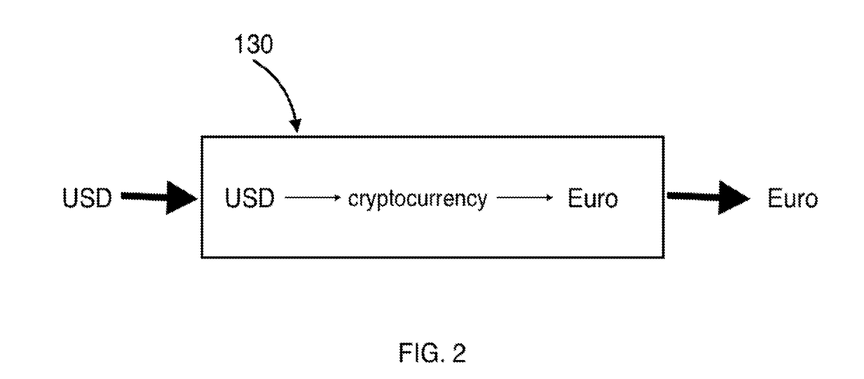

FIG. 2 illustrates an example cryptocurrency conversion module according to particular embodiments described herein. The cryptocurrency conversion module may be understood to be the currency converter 130 from FIG. 1. Illustrated is the currency converter 130. To continue the above example and not by way of limitation, as shown in the figure, a first form of traditional currency (e.g., USD) may enter the currency converter 130. At this point, the first form of traditional currency may be in the possession and control of the online payment system 540. The first form of traditional currency may remain under the control of the online payment system 546 until it is transferred into a bank account associated with the second user. At some point, the first form of traditional currency may be converted to cryptocurrency. This may be understood to be a first conversion, from the first form of traditional currency into cryptocurrency. The first conversion need not take place immediately upon receipt of the first form of traditional currency at the online payment system, but may take place immediately, or after any amount of time. The first conversion may convert the first form of traditional currency into cryptocurrency, and the cryptocurrency may be an existing form of cryptocurrency (e.g., bitcoin, XRP, etc.), or the cryptocurrency may be a unique cryptocurrency associated with online payment system 540. In this case, online payment system 540 may create and maintain its own universal ledger and otherwise perform the necessary functions to support its own form of cryptocurrency.

After the first conversion has occurred, a second conversion may occur. The cryptocurrency may be converted into a second form of traditional currency. This second form of traditional currency may be the same or different than the first form of traditional currency. As an example and not by way of limitation, the second conversion may convert the cryptocurrency into Euros. Alternatively, the second conversion may convert the cryptocurrency back into USD. In some embodiments, the determination of what currency the second form of traditional currency will be converted to may depend on the payee, who may designate the form of currency that she wishes to receive. The payee may designate any form of currency (e.g., USD, Euro, British Pound, Yen, Rupee, etc), including cryptocurrency (e.g., bitcoin, XRP, etc.) to which the cryptocurrency may be converted.

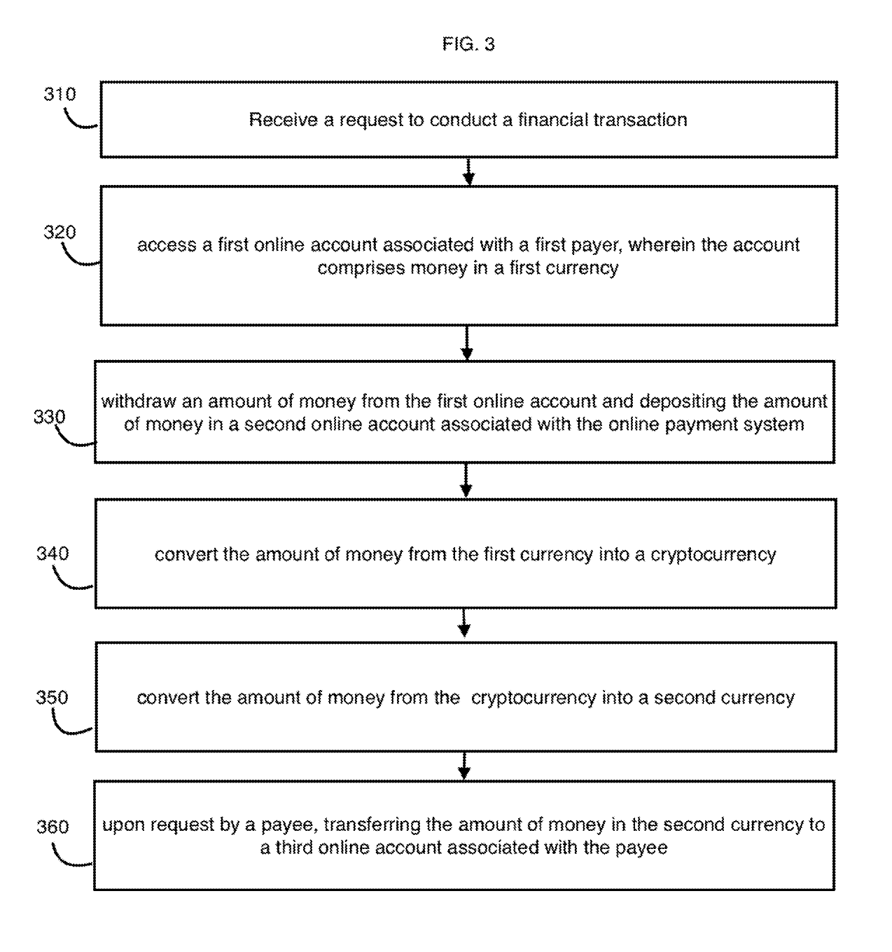

FIG. 3 illustrates an example method for using cryptocurrency to provide near instant end-to-end transactions with low associated costs. At step 310, the method may begin when a computer server receives a request to conduct a financial transaction. The computer server may be associated with an online payment system 540. The request may be made by a payer or a payee. Payer may be understood to mean any person or entity that pays money to another person or entity. Payee may be understood to mean any person or entity that receives money from a payer. If the request is made by a payer, the payer may wish to pay a payee. At step 320, the computer server may access a first online account associated with a first payer, wherein the account comprises money in a first currency. The first online account may be any type of online bank account (e.g., CapitalOne360 Savings or Checking, Charles Schwab, etc.), or any type of traditional bank account with online services (e.g., Wells Fargo savings or checking, Bank of America checking or savings, etc.). Alternatively, the account may be a credit account. The first currency may be any form of currency, both traditional (e.g., USD, Euro, British Pound, Yen, Rupee, etc.) or cryptocurrency (bitcoin, ripple, etc.). At step 330, the computer server may withdraw an amount of money from the first online account and deposit the amount of money in a second online account associated with the online payment system. This may be understood as a normal transfer of money from the first account into the second account. At step 340, the computer server may convert the amount of money from the first currency into a crypto currency. This may be accomplished via a third party cryptocurrency organization, or via a system created and maintained by the online payment system 540. If accomplished via the latter route, the online payment system may also create a universal ledger to monitor the transactions involving this cryptocurrency. This universal ledger may be maintained similar to other ledgers that monitor the transactions involving other forms of cryptocurrency (e.g., bitcoin), or it may monitor transactions in unique ways. At step 350, the computer server may convert the amount of money from the cryptocurrency into a second currency. The second currency may be a traditional form of currency (e.g., USD, Euro, British Pound, Yen, Rupee, etc.). At step 360, upon request by a payee, the computer server may transfer the amount of money in the second currency to a third online account associated with the payee.

In various embodiments, the request to conduct the financial transaction comprises a request from the payer to pay a payee. In other embodiments, the request to conduct the financial transaction comprises a request from the payee to receive payment from the payer. It is contemplated that a request in either situation may occur. The first online account may be associated with a payer, the second online account may be associated with the online payment system, and the third online account may be associated with a payee.

In various embodiments, the computer server machine may withdraw the amount of money from the first online account only after receiving a confirmation from the payer that the computer server machine is authorized to withdraw the amount of money from the first online account. This may occur in the context of a payee requesting payment from a payer. In order to avoid payees simply withdrawing money from accounts at their own discretion, the online payment system may require the approval of the payer prior to withdrawing money from the payer's account.

In various embodiments, when the request to conduct the financial transaction is made, the computer server may determine an exchange rate between the first currency and the second currency, wherein converting the amount of money from the cryptocurrency into the second currency is based on the exchange rate. This may address a potential problem of fluctuating exchange rates and normal market forces. As an example and not by way of limitation, a user Alex, living in Oklahoma, may wish to transfer USD to another user Carlos, in Mexico, who desires to receive payment in Pesos. The computer server may withdraw money from Alex's account, and either immediately convert it to cryptocurrency, or the online payment system may retain it temporarily. After the online payment system withdraws the money from Alex's account, it may remain with the online payment system until Carlos transfers it into his account. The time it takes Carlos to transfer the money may be entirely dependent on him. It may take minutes, days, or weeks for Carlos to transfer the money. In the interim time, the exchange rate from USD to Pesos may fluctuate. Thus, if Alex originally paid Carlos $100 USD on January 1, the $100 USD may be worth 1917 Pesos. However, after three or four weeks, the exchange rate may have changed, and the $100 USD may now be worth only 1400 Pesos. To address this problem, the online payment system may determine an exchange rate and convert the first form of traditional currency into cryptocurrency and the cryptocurrency into the second form of traditional currency at any point based on the determined exchange rate. This conversion may occur regardless of the current exchange rate.

In various embodiments, the computer server may create or maintain a ledger on which all transactions of the online payment system are recorded and viewable by all users of the online payment system. Alternatively, the ledger may be viewable by only some of the users of the online payment system. Alternatively, the ledger may be viewable by third parties, or by a combination of users and third parties. The ledger may be created and maintained using blockchain techniques. The ledger may be thought of as a database that records all transactions conducted by the online payment system. The ledger may be viewable and may provide information about each transaction conducted by the online payment system, including the date and time of each transaction, the assets involved, and the parties involved. In various embodiments, an asset may be traceable back to its origin or to when it first entered the blockchain. Each asset (e.g., unit of currency or cryptocurrency) may have a unique token assigned to the asset that acts as an identifier of that particular asset. Such tokens may be encrypted, such that they are not easily cloned or manipulated. Each party to each transaction may have a unique token that identifies that particular party. In various embodiments, the tokens assigned to a particular party may change from transaction to transaction. These tokens may be traceable by the particular party or by other users with the requisite authorization.

In various embodiments, the computer server may add a fee to be paid by either the payer or the payee, wherein the fee is based on a degree of trust between two of: the payer, the payee, or the online payment system. In various embodiments, transactions may be limited only to those users whose degree of trust exceeds a predetermined threshold. The degree of trust may be based on previous transactions, other online activity (e.g., FACEBOOK activity, AMAZON purchases, LINKEDIN activity, etc.). The degree of trust may also be based on the number of connections a user has on various social networking websites, or on other online activity (e.g., YELP reviews).

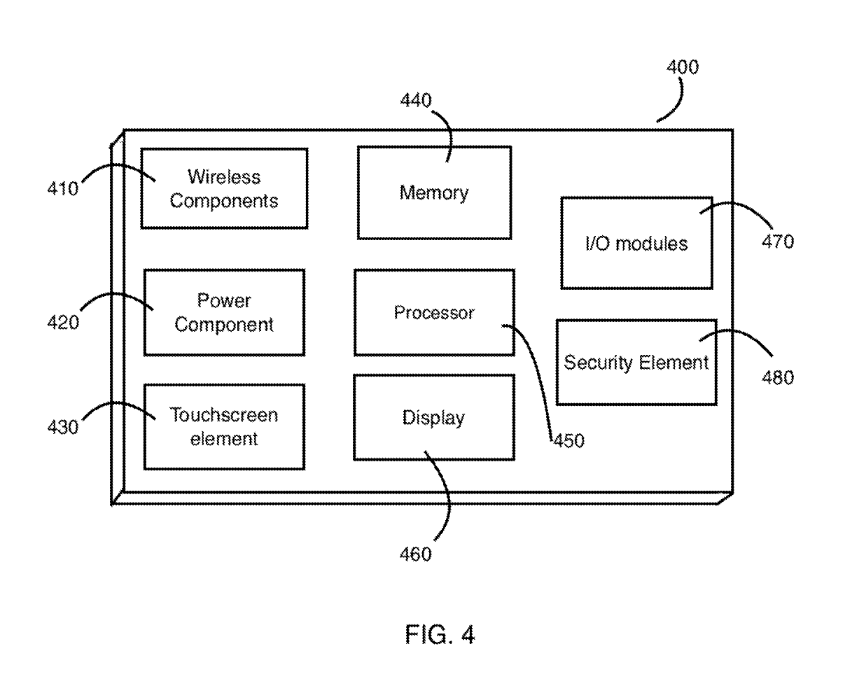

In order to provide the functionality described above, FIG. 4 illustrates an example set of basic components of a computing device 400. In some embodiments, the device may include at least one processor 450 for executing instructions that can be stored in at least one memory device or element 440. As would be apparent to one of ordinary skill in the art, the device can include many types of memory, data storage or computer-readable storage media, such as a first data storage for program instructions for execution by the processor 450, the same or separate storage can be used for images or data, a removable storage memory can be available for sharing information with other devices, etc. The device typically will include some type of display element 460, such as a touch screen, electronic ink (e-ink), organic light emitting diode (OLED) or liquid crystal display (LCD), although devices such as portable media players might convey information via other means, such as through audio speakers. The device in some embodiments may include at least one or several I/O modules 470. Such I/o modules may include an image capture element, such as one or more cameras that are able to image a user, people, or objects in the vicinity of the device. In at least some embodiments, the device can use the image information to determine gestures or motions of the user, which will enable the user to provide input through the portable device without having to actually contact and/or move the portable device. An image capture element also can be used to determine movement of the device. An image capture element can include any appropriate technology, such as a CCD image capture element having a sufficient resolution, focal range and viewable area, to capture an image of the user when the user is operating the device. The device can include at least one additional input device able to receive conventional input from a user. This conventional input can include, for example, a push button, touch pad, touch screen, wheel, joystick, keyboard, mouse, trackball, keypad or any other such device or element whereby a user can input a command to the device. These I/O modules could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device. As such, the I/O modules may include a microphone, as well as motion sensors.

The example device also includes one or more wireless components 410 operable to communicate with one or more electronic devices within a communication range of the particular wireless channel. The wireless channel can be any appropriate channel used to enable devices to communicate wirelessly, such as Bluetooth, cellular, or Wi-Fi channels. It should be understood that the device can have one or more conventional wired communications connections as known in the art. The example device includes various power components 420 known in the art for providing power to a computing device, which can include capacitive charging elements for use with a power pad or similar device as discussed elsewhere herein. The example device also can include at least one touchscreen and/or pressure-sensitive element 430, such as a touch sensitive material around a casing of the device, at least one region capable of providing squeeze-based input to the device, etc. In some embodiments this material can be used to determine motion, such as of the device or a user's finger, for example, while in other embodiments the material will be used to provide specific inputs or commands.

In some embodiments, the device 400 may include the ability to activate and/or deactivate detection and/or command modes, such as when receiving a command from a user or an application, or retrying to determine an audio input or video input, etc.

The example device includes a security element 480 for verifying that a user has authority to access certain applications and/or data on the example device. The authentication element, in one example, is a biometric device. The biometric device could be a voice recognition device, a facial recognition device, an iris scan recognition device, a retinal scan recognition device, a fingerprint recognition device, or a device that includes one or more of the foregoing functionalities. Also, while pin or password-based authentication could be performed by, for example, processor 450 and memory 440, in one instance, the pin or password-based authentication can also be performed by the security element 480.

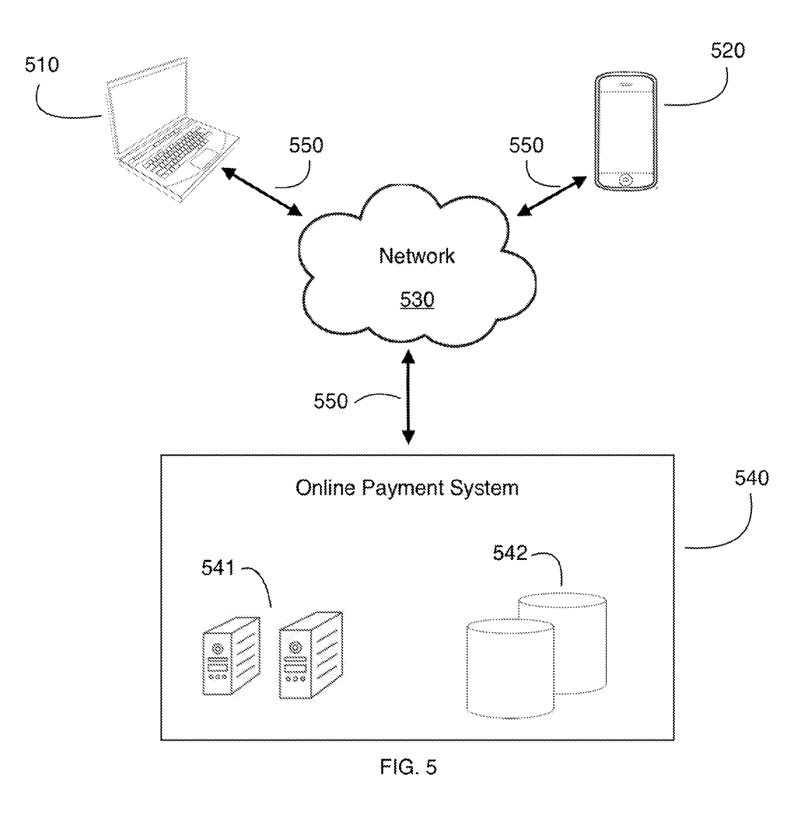

FIG. 5 illustrates an example environment for implementing aspects in accordance with various embodiments. As will be appreciated, although a Web-based environment is used for purposes of explanation, different environments may be used, as appropriate, to implement various embodiments. The system includes an electronic client devices 510 and 520. Such devices are examples only; it is contemplated that electronic client devices may include any appropriate device operable to send and receive requests, messages or information over an appropriate network 530 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes an online payment system 540, comprising at least one application server 541 and a data store 542. It should be understood that there can be several application servers, layers or other elements, processes or components, which may be chained or otherwise configured, which can interact to perform tasks such as obtaining data from an appropriate data store. It is contemplated that in addition to application server 541, other types of servers may also be included, such as web servers, file servers, and the like. As used herein, the term “data store” refers to any device or combination of devices capable of storing, accessing and retrieving data, which may include any combination and number of data servers, databases, data storage devices and data storage media, in any standard, distributed or clustered environment. The application server 541 can include any appropriate hardware and software for integrating with the data store 542 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by a Web server in the form of HTML, XML or another appropriate structured language in this example. The handling of all requests and responses, as well as the delivery of content between the client devices 510 and 520 and the application server 541, can be handled by the Web server. It should be understood that the Web and application servers are not required and are merely example components, as structured code discussed herein can be executed on any appropriate device or host machine as discussed elsewhere herein.

The data store 542 can include several separate data tables, databases or other data storage mechanisms and media for storing data relating to a particular aspect. For example, the data store illustrated includes mechanisms for storing content and user information, which can be used to service online payments more efficiently. It should be understood that there can be many other aspects that may need to be stored in the data store, such as page image information and access rights information, which can be stored in any of the above listed mechanisms as appropriate or in additional mechanisms in the data store 542. The data store 542 is operable, through logic associated therewith, to receive instructions from the application server 541 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 510 or 520. Information for a particular item of interest can be viewed in a dedicated page or window of the browser.

Each server may include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system FIG. 5 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code; or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader scope of the invention as set forth in the claims.

In various embodiments, the above discussion may be described as a series of steps for assessing trust to facilitate blockchain transactions. At the first step, a computer server associated with the online payment system 540 identifies one or more online activities performed by a user of the online payment system 540. At at the second step, a computer server associated with the online payment system 540 may categorize the identified online activities into one or more categories. This categorization may be based on pre-defined categorizations determined by online payment system 540. In some embodiments, online payment system 540 may generate a plurality of categories for various online activities. Such categories may include providing personal information, subscribing to online services, interacting with users on an online social network, and the like. Each categorization may be assigned a particular trust score. For example, providing personal information may receive a trust score of 1. This means that any action that falls into this particular category may receive a trust score of 1. In some embodiments, trust scores for particular actions may be adjusted after they are categorized. For example, providing an email address is providing personal information, and may thus receive a trust score of 1. But providing a name, address, and date of birth may be indicative of higher trustworthiness, and may be assigned a trust score of 2. In some embodiments, each action may receive a trust score of 2. At the third step, a computer server associated with the online payment system 540 may generate, based on the categorization of the online activities, a trust score to assign to the user. This may be done by summing all the trust scores associated with all the actions the user has performed online. In some embodiments, certain actions may be adjusted by a multiplier. For example, any action-performed in association with a large online social network, (e.g., LinkedIn) may have a multiplier of 1.5×. This may indicate that the actions performed in association with the large online social network are more indicative of trustworthiness than other actions. At the fourth step, a computer server associated with the online payment system 540 may receive a request to conduct a financial transaction from the user. In various embodiments, the request to conduct the financial transaction comprises a request from the payer to pay a payee. In other embodiments, the request to conduct the financial transaction comprises a request from the payee to receive payment from the payer. It is contemplated that a request in either situation may occur. The first online account may be associated with a payer, the second online account may be associated with the online payment system, and the third online account may be associated with a payee. At the fifth step, a computer server associated with the online payment system 540 may dispense with a waiting period to transfer a sum of money if the trust score is above a predetermined threshold level. The above discussion is merely an example; this disclosure contemplates any steps suitable for assessing trust based on the online actions of a user. Furthermore, the steps discussed above need not be performed in a specific order.

In at least one embodiment, the method is performed in a block chain transaction. Such a transaction may be performed by online payment system 540. Online payment system 540 may utilize any suitable protocol for performing blockchain transactions, or may create its own form of cryptocurrency to perform the blockchain transaction. As an example and not limitation, online payment system may use bitcoin to conduct payments and may perform the trust assessment under the bitcoin protocol.

In at least one embodiment, the categorization comprises at least three categorizations, the categorizations comprising low trust, moderate trust, and high trust. The number of categorizations need not be three; there may be many more categories, each indicating how indicative of trustworthiness a particular action is, as determined by online payment system 540. For example, providing an email address to an online subscription service may be indicative of low trust, because people often make “junk” email accounts (e.g., accounts that the user does not plan on using). If, however, the user provides her name along with her email address, and her email address matches her name, this may indicate a higher level of trust, because an email account having the user's name in the address may be less likely to be a “junk” account. As another example, if the user posts lots of photos on social media, actively comments on discussion boards, and freely associates with others via the Internet, this may be indicative of a higher level of trustworthiness.

In at least one embodiment, the categorization comprises at least three categorizations, each categorization being a numerical value assigned to a given activity, wherein activities representing higher levels of trust are assigned higher numerical values. The number of categorizations need not be three; there may be many more categories, each indicating how indicative of trustworthiness a particular action is, as determined by online payment system 540. For example, online payment system 540 may determine that actions indicating a relatively low level of trustworthiness be assigned a score of “1.” Online payment system 540 may determine that actions indicating a relatively moderate level of trustworthiness be assigned a score of “2.” online payment system 540 may determine that actions indicating a relatively high level of trustworthiness be assigned a score of “3.” For example, providing an email address to an online subscription service may be indicative of low trust, because people often make “junk” email accounts (e.g., accounts that the user does not plan on using), and thus may be assigned a score of 1. If, however, the user provides her name along with her email address, and her email address matches her name, this may indicate a higher level of trust, because an email account having the user's name in the address may be less likely to be a “junk” account. Thus, this action may be assigned a score of 2. As another example, if the user posts lots of photos on social media, actively comments on discussion boards, and freely associates with others via the Internet, this may be indicative of a higher level of trustworthiness, and may warrant a score of 3.

In at least one embodiment, the online activities comprise: setting up an account on an online social network, providing personal information to one or more online services; commenting on, liking, or sharing content over the Internet, or providing personal identification to an online service. Any number of suitable online activities may be used to evaluate a level of trustworthiness of a user. Such online activities may additionally include subscribing to one or more online services such as a subscription newsletter, ordering product on e-commerce websites, sending or receiving messages, and the like.

1. A method, comprising:
storing, on a physical memory device, computer-executable instructions for identifying sources of content to be included in a content feed addressable to the user and providing content generated by the sources to the user; and
providing a processor for accessing and executing the instructions, that when executed by the processor:
identifies one or more online activities performed by a user of an online payments system, the activities being unrelated to the online payments system;
categorizes the identified online activities into one or more categories;
generates, based on the categorization of the identified online activities, a trust score to assign to the user;
receives a request to conduct a financial transaction from the user; and
dispenses with a waiting period to transfer a sum of money if the trust score is above a predetermined threshold level.

2. The method of claim 1, wherein the method is performed in a block chain transaction.

3. The method of claim 1, wherein the categorization comprises at least three categorizations, the categorizations comprising low trust, moderate trust, and high trust.

4. The method of claim 1, wherein the categorization comprises at least three categorizations, each categorization being a numerical value assigned to a given activity, wherein activities representing higher levels of trust are assigned higher numerical values.

5. The method of claim 1, wherein the online activities comprise: setting up an account on an online social network, providing personal information to one or more online services; commenting on, liking, or sharing content over the Internet, or providing personal identification to an online service.

6. A method of assessing trust of a user of an online payment system, the method comprising:
identifying one or more online activities performed by a user of an online payments system, the activities being unrelated to the online payments system;
categorizing the identified online activities into one or more categories;
generating, based on the categorization of the identified online activities, a trust score to assign to the user;
receiving a request to conduct a financial transaction from the user; and
dispensing with a waiting period to transfer a sum of money if the trust score is above a predetermined threshold level.

7. The method of claim 6, wherein the method is performed in a block chain transaction.

8. The method of claim 6, wherein the categorization comprises at least three categorizations, the categorizations comprising low trust, moderate trust, and high trust.

9. The method of claim 6, wherein the categorization comprises at least three categorizations, each categorization being a numerical value assigned to a given activity, wherein activities representing higher levels of trust are assigned higher numerical values.

10. The method of claim 6, wherein the online activities comprise: setting up an account on an online social network, providing personal information to one or more online services; commenting on, liking, or sharing content over the Internet, or providing personal identification to an online service.

11. One or more computer-readable memory components coupled to one or more processors, and software executable by the processors and memory components, the software operable to:
identify one or more online activities performed by a user of an online payments system, the activities being unrelated to the online payments system;
categorize the identified online activities into one or more categories;
generate, based on the categorization of the identified online activities, a trust score to assign to the user;
receive a request to conduct a financial transaction from the user; and
dispense with a waiting period to transfer a sum of money if the trust score is above a predetermined threshold level.

12. The components and software of claim 11, wherein the method is performed in a block chain transaction.

13. The components and software of claim 11, wherein the categorization comprises at least three categorizations, the categorizations comprising low trust, moderate trust, and high trust.

14. The components and software of claim 11, wherein the categorization comprises at least three categorizations, each categorization being a numerical value assigned to a given activity, wherein activities representing higher levels of trust are assigned higher numerical values.

15. The components and software of claim 11, wherein the online activities comprise:
setting up an account on an online social network, providing personal information to one or more online services; commenting on, liking, or sharing content over the Internet, or providing personal identification to an online service.
